(19) United States
(12) Patent Application Publication
(10) Pub. No.: US 2020/0298032 A1
(43) Pub. Date: Sep. 24, 2020

(54) MASK APPARATUSES AND APPROACH

(71) Applicant: RZ INDUSTRIES LLC, Burnsville, MN (US)

(72) Inventors: Steve Gordon Torbenson, Lakeville, MN (US); Jordan Daniel Torbenson, Lakeville, MN (US)

(21) Appl. No.: 16/898,021

(22) Filed: Jun. 10, 2020

Related U.S. Application Data
(63) Continuation-in-part of application No. 16/593,574, filed on Oct. 4, 2019.
Application No. 16/593,574 is a continuation of application No. 14/732,275, filed on Jun. 5, 2015, now Pat. No. 10,434,341.
Application No. 14/732,275 is a continuation of application No. PCT/US19/26564, filed on Apr. 9, 2019.
(60) Provisional application No. 62/654,926, filed on Apr. 9, 2018.

(51) Int. Cl. A62B 23/02; A62B 18/08; A62B 18/02; A62B 18/00; A62B 23/00; A41D 13/11; A62B 7/10

(52) U.S. Cl. CPC A62B 23/025; A62B 18/084; A62B 18/02; A62B 18/00; A62B 23/00; A41D 13/1138; A62B 9/04; A41D 13/1161; A62B 18/025; A41D 13/11; A62B 23/02; A41D 13/1107; A62B 7/10

(57) ABSTRACT

Aspects of various embodiments herein may be implemented as follows. An apparatus has a material shell, which may be conformed to a user's face, and a securing portion connected to the shell that operates to secure a filter, such as to the user's face with the filter covering the user's nose and mouth. A securing force can be applied to the filter via the first material portion, thereby sealing the filter around the user's nose and mouth. Various implementations involve multiple couplers at an attachment region between the material shell and securing portion, which facilitate the application of forces with two or more degrees of freedom for securing the filter to the user's face. Further, various implementations facilitate replacing filters utilized with the mask shell.

### FIELD

Aspects of various embodiments are directed to mask apparatuses and related approaches.

### BACKGROUND

Masks are useful for a variety of applications, ranging from industrial to medical to recreational applications. For instance, industrial masks are often useful or required for certain applications, and can enhance worker safety. Medical masks can be important for ensuring that medical personnel are protected from exposure. Recreational masks can be useful for filtering dust and other particles.

While useful, many masks are uncomfortable to wear, difficult to fit, and may result in less than desirable protection. For instance, many disposable masks are general in size and shape and are difficult to properly conform to individual faces, such as to accommodate facial hair and other varied facial characteristics, which can result in an improper seal. An improper seal can permit passage of particulates, and can result in fogging of glasses (e.g., via improperly fitting nose pieces). In addition, it can be challenging to manufacture effective and well-fitting disposable masks efficiently. These and other matters have presented challenges to the use and implementation of masks for a variety of applications.

### SUMMARY

Various example embodiments are directed to masks, and mask apparatuses involving a mask shell, and their implementation.

In accordance with one or more embodiments, an apparatus includes a filter configured and arranged to conform to a user's face and to filter air while conformed to the user's face, and a mask shell and securing mechanism that secure the filter to the user's face. The mask shell is configured and arranged to conform to the user's face with the filter between the mask shell and the user's face and held against the user's face, with the mask shell extending around a perimeter region of the filter and permitting air to pass between an ambient environment in contact with the filter and the user's nose and mouth directly via the filter. The mask shell is further configured and arranged to seal the filter around the user's nose and mouth by applying pressure to the filter and the user's face at the perimeter region of the filter. The securing mechanism includes opposing portions connected to respective sides of the mask shell and configured and arranged to, with the filter positioned between the mask shell and the user's face, seal the filter around the user's nose and mouth by utilizing the user's head for applying a securing force to the filter via the respective sides of the mask shell, with the respective sides being positioned on opposing sides of the user's face, in a direction toward the user's face.

Another embodiment is directed to an apparatus comprising a mask shell and a securing mechanism. The mask shell is configured and arranged to conform to the user's face with a filter between the mask shell and the user's face, and held against the user's face. Under such conditions the mask shell extends around a perimeter region of the filter and permits air to pass between an ambient environment in contact with the filter and the user's nose and mouth via the filter. The mask shell is further configured to seal the filter around the user's nose and mouth by applying pressure to the filter and the user's face at the perimeter region of the filter. The securing mechanism includes opposing portions connected to respective sides of the mask shell and, for each of the opposing portions, first and second (separate) couplers that respectively connect the opposing portion to the mask shell. The first and second couplers are configured and arranged with the mask shell and securing mechanism to provide, via each of the first and second couplers, respective degrees of freedom of relative motion between the mask shell and the securing mechanism. The first and second couplers further seal the filter around the user's nose and mouth by utilizing the user's head for applying a securing force to the filter via the respective sides of the mask shell, with the respective sides being positioned on opposing sides of the user's face, in a direction toward the user's face.

Another embodiment is directed to an apparatus comprising a filter configured and arranged to conform to a user's face and to filter air while conformed to the user's face, and a mask shell including a first material portion and a second securing portion. The first material portion is configured and arranged to conform to the user's face and therein position the filter to cover the user's nose and mouth, and to pass air for breathing to the filter. The second securing portion is connected to the first material portion and configured and arranged with the first material portion and the filter to, with at least a portion of the filter positioned between the first material portion and the user's face, secure the filter to the user's face with the filter covering the user's nose and mouth, by applying a securing force to the filter via the first material portion in a direction toward the user's face and thereby sealing the filter around the user's nose and mouth. In some implementations, the first material portion is configured and arranged with the second securing portion to conform the filter to the user's face by deforming the filter along a contour that surrounds the user's nose and mouth. Further, the filter and mask shell may be configured and arranged to move independently of one another in an unsecured state, and facilitate a secured state with the second securing portion securing an inner surface of the first material portion with an outer surface of the filter. In the secured state, an inner surface of the filter is in contact with and secured to the user's face, in which the securing force secures the filter relative to the mask shell.

The above discussion/summary is not intended to describe each embodiment or every implementation of the present disclosure. The figures and detailed description that follow also exemplify various embodiments.

### DESCRIPTION OF THE FIGURES

Various example embodiments may be more completely understood in consideration of the following detailed description in connection with the accompanying drawings, in which:

FIG. 1A shows a mask apparatus with a double-loop ear strap, as may be implemented in accordance with one or more embodiments;

FIG. 1B shows a mask apparatus with a double-connected hook-and-loop strap, as may be implemented in accordance with one or more embodiments;

FIG. 1C shows a mask apparatus with a double strap for securement around a user's head, as may be implemented in accordance with one or more embodiments;

FIG. 2A shows a mask apparatus with a single-button detachable double-loop ear strap, as may be implemented in accordance with one or more embodiments;

FIG. 2B shows a mask apparatus with a single-button detachable hook-and-loop strap, as may be implemented in accordance with one or more embodiments;

FIG. 2C shows a mask apparatus with a single-button detachable double strap for securement around a user's head, as may be implemented in accordance with one or more embodiments;

FIG. 3A shows a mask apparatus with a two-button detachable double-loop ear strap, as may be implemented in accordance with one or more embodiments;

FIG. 3B shows a mask apparatus with a two-button detachable double strap for securement around a user's head, as may be implemented in accordance with one or more embodiments;

FIG. 3C shows a mask apparatus with a two-button detachable hook-and-loop strap, as may be implemented in accordance with one or more embodiments;

FIG. 4A shows a mask apparatus with a two-button detachable double head strap, as may be implemented in accordance with one or more embodiments;

FIG. 4B shows a mask apparatus with a two-button detachable hook-and-loop strap and accessory items, as may be implemented in accordance with one or more embodiments;

FIG. 5 shows a filter, as may be implemented in accordance with one or more embodiments;

FIG. 6 shows a filter with a vent assembly, as may be implemented in accordance with one or more embodiments;

FIG. 7 shows a filter with a vent assembly, as may be implemented in accordance with one or more embodiments;

FIG. 8 shows a filter with a vent assembly, as may be implemented in accordance with one or more embodiments;

FIG. 9 shows a vent assembly for use with a filter, as may be implemented in accordance with one or more embodiments;

FIG. 10 shows a mask apparatus, as may be implemented in accordance with one or more embodiments;

FIG. 11 shows a mask apparatus, as may be implemented in accordance with one or more embodiments;

FIG. 12 shows a mask apparatus with insertion of a replaceable mask, in accordance with various embodiments;

FIG. 13 shows a mask apparatus with insertion of a replaceable mask, in accordance with various embodiments;

FIG. 14A shows a mask apparatus with a replaceable mask having a central valve region, in accordance with one or more embodiments;

FIG. 14B shows a mask apparatus with a replaceable mask having a central valve region as in 14A, with a different securing mechanism, in accordance with one or more embodiments;

FIGS. 15A-15D show a mask apparatus in accordance with one or more embodiments, in which:
FIG. 15A shows a front right perspective view of a mask shell,
FIG. 15B shows a rear left perspective view of the mask shell,
FIG. 15C shows a rear view of the mask shell, and
FIG. 15D shows the mask shell with a filter coupled thereto;

FIG. 16 shows a dual strap mask apparatus as applied to a user, in accordance with one or more embodiments;

FIG. 17 shows an ear mask apparatus as applied to a user, in accordance with one or more embodiments; and

FIG. 18 shows a single strap mask apparatus as applied to a user, in accordance with one or more embodiments.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Aspects of the present disclosure are believed to be applicable to a variety of different types of apparatuses, systems and methods involving masks, and as may particularly involve interchangeable strap systems that may be integrated with a mask or mask shell. Various embodiments are directed toward such aspects for use with replaceable masks and a shell-type approach that facilitates fitment of the replaceable mask, utilizing the interchangeable strap system. In certain implementations, aspects of the present disclosure have been shown to be beneficial when used in the context of disposable masks that can suffer from fitment problems such as those described above, with improved sealing around a user's face and related comfort. While not necessarily so limited, various aspects may be appreciated through a discussion of examples using such exemplary contexts.

In connection with one or more embodiments, a mask shell has an inner perimeter defining an opening in the mask shell via which an external surface of a filter can exposed when the filter is coupled to the mask shell. The mask shell further has a securing portion configured to, in use, secure the filter to a user's face with the filter covering the user's nose and mouth and the inner perimeter of the first material portion extending around the user's nose and mouth. The securing portion may thus apply a securing force to the filter via the mask shell in a direction toward the user's face, thereby sealing the filter around the user's nose and mouth. Various embodiments include the filter as well.

In some embodiments, the mask shell has a reinforced portion having a fastener such as a snap, which is configured to secure the filter to the mask shell. The mask shell further has a breathable portion configured to facilitate enhanced passage of air relative to the reinforced portion, with the reinforced portion lying between the inner perimeter and the breathable portion. Accordingly, the reinforced portion may be bound by inner perimeter and the breathable portion, and the breathable portion may be bound by the reinforced portion and the second securing portion. In connection with such an embodiment or embodiments, it has been recognized/discovered that the placement of a reinforced material, such as a more heavily stitched or denser material, in a portion of the mask shell including the fastener enhances durability of the mask shell for repeated attachment and replacement of filters, while the breathable portion facilitates comfort.

Various embodiments are directed to a mask system with respective connections between a mask shell and a securing component, each of which provide one or more degrees of freedom of relative motion between the mask shell and the securing component. In connection with one or more embodiments, it has been recognized/discovered that utilizing such degrees of freedom facilitates fitment of the mask shell, for further securing a mask coupled to or otherwise affixed with the mask shell to a user's face. Various aspects provide a flexible mask design that adapts to provide different fitment for different people. A single mask shell may be utilized for coupling with a multitude of disparate filters, allowing a user to interchange and accommodate various filters. The various degrees of freedom, such as may be provided using a pivoting system, may increase mobility while interchangeable strap options may be provided to increase functionality, efficiency and comfortability in masks.

In accordance with one or more embodiments, an apparatus includes a filter configured and arranged to conform to a user's face and to filter air while conformed to the user's face, and a mask shell and securing mechanism that secure the filter to the user's face. The mask shell extends around a perimeter region of the filter, with the filter between the mask shell and the user's face, and permits air to pass between an ambient environment in contact with the filter and the user's nose and mouth directly via the filter (e.g., without necessarily passing through the mask shell). This approach facilitates fitment of the filter and replacement of the filter, without obstructing air flow through the filter and while maintaining a secure seal of the filter to the user's face. The mask shell may seal the filter around the user's nose and mouth by applying pressure to the filter and the user's face at the perimeter region of the filter. The securing mechanism includes opposing portions connected to respective sides of the mask shell and that operate, with the filter positioned between the mask shell and the user's face, to seal the filter around the user's nose and mouth. The user's head is utilized for applying a securing force to the filter via the respective sides of the mask shell, with the respective sides being positioned on opposing sides of the user's face, in a direction toward the user's face.

The securing mechanism may be implemented in a variety of manners. In some embodiments the securing mechanism includes, for each opposing portion, a first detachable coupler connected to the mask shell, and a second detachable coupler connected to the mask shell. The second detachable coupler is separate from the first detachable coupler and moves independently of the first detachable coupler. The first and second detachable couplers apply the securing force in different directions relative to one another.

In some implementations, first and second (separate) couplers connect the securing mechanism to the mask shell, providing respective degrees of freedom to a common coupling point (e.g., on a common side of the mask shell). The first and second couplers operate with the mask shell and securing mechanism to provide, via each of the first and second couplers, the respective degrees of freedom of relative motion between the mask shell and the securing mechanism. The couplers may, for example, provide detachable connectivity of the securing mechanism and the mask shell, facilitating coupling and decoupling, and exchange of various types of securing mechanisms. In some implementations, one or both of the first and second couplers includes a first portion connected to the securing mechanism and a second portion connected to the mask shell, the first and second portions being configured and arranged to connect the mask shell to the securing mechanism by detachably engaging with one another. The first and second couplers may provide respective degrees of freedom for applying forces in different directions that respectively provide different securing forces upon the mask and the user's face.

In some embodiments, the mask shell has an open region having a perimeter that, when secured to the user's face, exposes an exterior surface region of the filter that is over the user's nose and mouth, with an interior surface region of the filter in contact with the user's face. For instance, the mask shell may extend around and secure a perimeter inner surface of the filter to the user's face, with the mask shell covering a perimeter outer surface of the filter. A central area of the outer surface of the filter is left uncovered by the mask shell, and thus exposed to communicate air directly between the central area of the outer surface of the filter and a corresponding central area of an inner surface of the filter.

In some embodiments, a valve component is coupled to pass air in a first direction through an opening in the filter, and to mitigate air from passing through the opening in the filter in a second direction that is opposite the first direction. The valve component may be secured to the filter and unconnected to the mask shell (e.g., as part of a replaceable filter), or secured to the mask shell as well. For the latter, the valve component may pass the air in the first direction through an opening in the mask shell, and mitigate air from passing through the opening in the mask shell in the second direction.

Another embodiment is directed to an apparatus comprising a mask shell and a securing mechanism as follows. The mask shell conforms to the user's face with a filter between the mask shell and the user's face, and held against the user's face. The mask shell extends around a perimeter region of the filter and permits air to pass between an ambient environment in contact with the filter and the user's nose and mouth via the filter. The mask shell also seals the filter around the user's nose and mouth by applying pressure to the filter and the user's face at the perimeter region of the filter. The mask shell may, for example, be implemented with an open region having a perimeter that, when secured to the user's face, exposes an exterior surface region of the filter that is over the user's nose and mouth, with a corresponding interior surface region of the filter in contact with the user's face.

The securing mechanism includes opposing portions connected to respective sides of the mask shell and, for each of the opposing portions, first and second (separate) couplers (e.g., detachable couplers) that respectively connect the opposing portion to the mask shell. The couplers operate with the mask shell and securing mechanism to provide, via each of the first and second couplers, respective degrees of freedom of relative motion between the mask shell and the securing mechanism. The couplers also seal the filter around the user's nose and mouth by utilizing the user's head for applying a securing force to the filter via the respective sides of the mask shell, with the respective sides being positioned on opposing sides of the user's face, in a direction toward the user's face. Certain embodiments also include the filter.

The couplers may be implemented in a variety of manners. For instance, the couplers may apply forces in different directions relative to one another, facilitating secure, comfortable fitment of the mask to the user's face. One or both of the couplers may include a first portion connected to the securing mechanism and a second portion connected to the mask shell, the first and second portions being operable to (e.g., detachably) connect the mask shell to the securing mechanism by detachably engaging with one another. The couplers may provide respective degrees of freedom that provide forces in different directions that respectively provide different securing forces upon the mask and the user's face.

According to various example embodiments, aspects of the present disclosure are directed to an apparatus and approach in which a user may place a mask on the inside of a shell. The shell and mask conform to one another and operate to secure the mask against the user's face, with the shell including one or more fasteners that couple to the user and provide a holding force that is translated through the shell to the mask. In some implementations, the shell covers the mask and allows air to pass through to the mask, and in other implementations the shell operates with the mask to secure the mask to a user's face while allowing a portion (e.g., a central portion) of the mask to remain exposed. This approach can assist in accurately conforming masks to a variety of different types of facial features, bone structure and sizes.

This approach also facilitates the use of a replacement mask material (e.g., for disposable masks) while providing robust fitment via the reusable shell. Comfort, safety and convenience aspects can all be addressed in this regard, which can be particularly helpful with disposable masks in which low cost can be desirable.

In various embodiments, a flexible material is used to provide a shell (e.g., a frame), that conforms to a replaceable mask. The shell may include, for example, neoprene, mesh material, a moisture-wicking material, cotton material, and/orpolyester material. The frame may include multiple openings via which a replaceable mask may be exposed, which can facilitate breathing through the replaceable mask. In some implementations, the shell operates to pass air though a mesh or perforated type structure, to the mask. The shell may have one, two or more straps that secure the shell and, when integrated therewith, a mask to a user. Such straps may include a head strap connected to the shell and/or other straps (e.g., via a hook-and-loop fastener or button). In further embodiments, a holding strap is included for loosely holding the shell around a user's neck while the shell is in an unsecured position (e.g., removed from the user's face).

In some embodiments, fitment and sealing of a shell and corresponding mask is carried out with a conforming component that draws the shell (and therein the mask) with a force against the user's face. In some embodiments, an elastic material extends around a user's nose and mouth and is operable to adjustably apply pressure in this context, providing and adjustable sealing force to the user's face. For instance, an elastic draw string having a rubber compression ring or a round elastic cord can be used to facilitate tensioning. The cord is secured, for example, using a tension ring or other component. In certain embodiments, elastic type material is integrated with the shell such that the elastic type material can be adjusted to accommodate masks of various sizes. Various embodiments employ a conforming component that applies an even, or nearly even, pressure along a path that encloses the user's nose and mouth, providing a seal between the mask and the user's face.

In some embodiments, a mask shell as characterized herein includes a deformable material that holds shape upon physical deformation, within the mask shell. For instance, a bendable aluminum piece of material can be sewn in the shell in an area that covers a user's nose when the shell is in place. The aluminum piece is bendable to conform the mask shell, and therein the mask, to the user's nose.

One or more embodiments employ elastic or other fitting/tightening components at target locations of the shell. In one embodiment, an elastic material is employed near a chin portion of the shell, to facilitate a tight seal around a user's chin. For instance, additional fabric may be applied at a chin region, relative to other portions of the shell, to facilitate the seal. In some embodiments, a strap is integrated with a chin region, for tightening the material at the chin.

In some implementations, an alignment component aligns masks to a shell as characterized herein. Such an alignment component may, for example, include a ridge or other structure that may be part of, or separate from, material that forms other portions of the shell. The alignment component operates to align removable masks relative to the shell, and facilitates proper fitment thereof (e.g., with an inner surface of the mask shell in contact with an outer surface of the filter).

A variety of accessories may be implemented to suit particular embodiments. In some embodiments, ear plugs, safety glasses, a storage pouch, or a light are attached to provide functionality. Certain embodiments employ additional material such as a bandana, dickey or neck scarf that can be useful in windy or cold weather environments. These components may be implemented with a variety of coupling or fastening approaches, such as hook-and-loop or button-type fasteners. A full-head balaclava may be incorporated for certain applications, which may alleviate the need for straps or fasteners.

A variety of masks may be implemented to suit a variety of applications. For instance, dust masks, chemical masks, medical masks and others can be implemented with a shell as discussed herein. These masks may be washable, disposable or usable over an extended period of time. Such masks may include, for example, those available from 3M Company of St. Paul, Minn.; Moldex of Culver City, Calif.; and Honeywell of Morristown, N.J.. In addition, a variety of mask sizes can be employed with a common shell. For instance, the shell may be sized with an opening that accommodates various sizes of masks, in which the shell interfaces with each mask to provide a proper seal to the user's face.

In various embodiments, a shell as characterized herein includes a sealing mechanism that mitigates or prevents moisture from reaching a user's glasses or other eyewear. Such approaches may involve nose pieces and/or other conforming components that conform the shell and/or a mask therein to a user's face. This approach can provide a better seal than, for example, a relatively weak strap system as may be employed with disposable masks. Moreover, the mask may be desirably sealed over facial features, facilitating filtration.

Various embodiments are directed to a mask shell having power connectivity for powering accessories. Positive and negative terminals are located on one or more portions of the mask at which accessory attachment is desired, and coupled to a power source. In some implementations, the terminals are coupled to conductors that extend to a remote power source, such as a battery that is located in another portion of the mask. In certain embodiments, a battery is stored in a pouch integrated in a rear portion of the mask shell. The conductors may be implemented with a switch that can be used to power or remove power from an accessory coupled to the terminals. In various embodiments, a cover or covers are included and couple to the terminals, providing a cover when the terminals are unused. Such an approach may be implemented with snap-type terminals, with button covers that couple to the snap-type terminals.

In accordance with one or more embodiments, an apparatus includes a first shell-type portion that conforms to a user's face with a filter placed between the shell and the user. A securing portion, such as a flexible material and straps, is connected to the first shell-type portion and secures the filter to the user's face by applying a force to the shell-type portion (e.g., by securing straps around the back of the user's neck). The filter is thus pressured by the mask to the user's face, covering the user's nose and mouth. Various embodiments further include the filter, which may be essentially freely-moving relative to the shell.

In various implementations, the first shell-type portion applies the securing force along a path of an inner surface of the filter that is in contact with the user's face, with the securing force being about equal along an entire length of the path. This approach is useful, for example, to mitigate issues relating to mask filter placement and securing (e.g., by deforming the filter along a contour that surrounds the user's nose and mouth), to mitigate leaking. An elastic material may be implemented along the path or other interface between the shell-like material and the filter to enhance the fitment and securing. As the securing portion may include robust straps, these straps can aide coupling of the filter to the user (e.g., relative to disposable masks). In certain embodiments, the first shell-type material portion has a central opening in which the filter inserts, and in which a portion of an outer surface of the filter is uncovered and another portion of the outer surface of the filter is covered by the first material portion. An elastic material around the opening may be implemented to conform the filter to the mask and user's face. The second securing portion secures the first material portion against the outer surface of the mask and secures an inner surface of the mask to the user's face.

Certain embodiments employ a securing portion to seal against a bridge of the user's nose, and therein inhibit moisture exhaled from the user from fogging eyewear worn by the user. This approach may be implemented with an inner surface of the nose portion in contact with the user's nose, while the first material portion secures the filter with an inner surface of the filter being in contact with a portion of the user's nose below a portion of the bridge with which the nose portion is in contact.

Various approaches herein involve the use of a replaceable or disposable filter, which can otherwise move independently of a shell or first material as described above. A second securing portion secures an inner surface of the shell with an outer surface of the filter, with an inner surface of the filter being in contact with and secured to the user's face with a securing force applied.

In various implementations, a securing portion as noted herein applies a settable pressure upon a shell for securing a filter to a user's face under respective conditions in which the user has no facial hair and in which the user has facial hair, thereby forming a seal via different amounts of pressure in each of the respective conditions. In certain implementations, the securing portion includes a chin strap configured and arranged to apply the settable pressure. The securing portion thus may, for example, be integrated with the shell, and/or be implemented in separate components coupled to the shell (e.g., a chin strap being separate from straps that extend around a user's neck). Various elastic cords may be similarly implemented to apply a settable force along a path that surrounds the user's nose and mouth, such as with a compression ring that maintains the settable force.

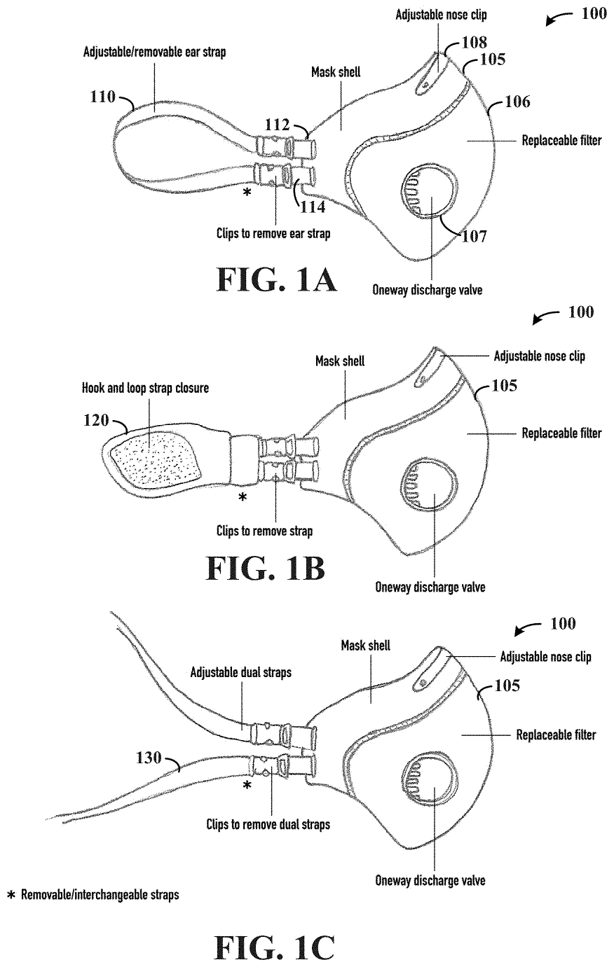

Turning now to the figures, FIGS. 1A-1C show a mask apparatus 100 with a mask shell 105, and a replaceable securement mechanisms 110, 120 and 130 as respectively shown in each figure. Securement mechanism 110 includes an adjustable/removable double-loop ear strap, securement mechanism 120 shows double-connected hook-and-loop strap, and securement mechanism 130 shows a double strap for securement around a user's head. The respective connection points (e.g., as shown at 112, 114 in FIG. 1A) of each securement mechanism each provide at least one degree of freedom in connection, facilitating desirable fitment. For instance, the straps 110 and 130 provide disparate movement for each of the respectively-coupled strap portions, improving fitment of the mask shell 105.

A replaceable filter 106 may be integrated with the mask shell 105, secured to the mask shell, or simply secured to a user's face via pressure applied thereto by the mask shell. Accordingly, the mask shell 105 applies pressure/securement around a perimeter of the replaceable filter 106, which is exposed in a central area thereof. The replaceable filter is shown with an optional discharge valve 107, which may be eliminated or replace with other valve types. Other components, such as adjustable nose clip 108, can be added to the apparatus.

Accordingly, FIGS. 1A-1C show example embodiments involving securement of a mask shell and filter to the head and/or neck of a user. Various other combinations of securement mechanisms may be used as well, and different combinations of securement mechanisms may be used.

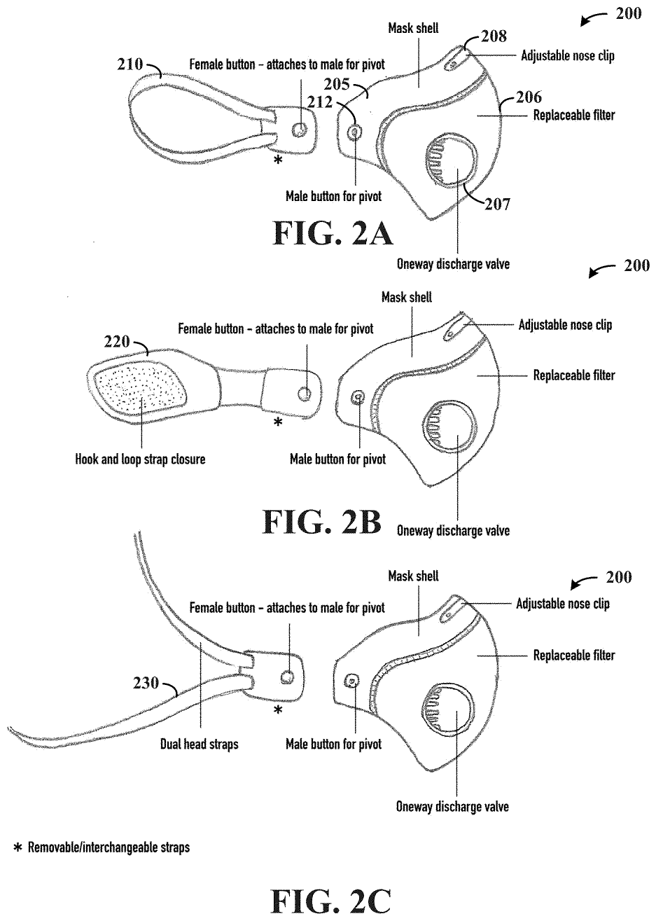

FIGS. 2A-2C show a mask apparatus 200 with respective single-button detachable securement mechanisms, including a double-loop ear strap 210 in FIG. 2A, a single-connected hook-and-loop strap 220 in FIG. 2B, and a double strap 230 in FIG. 2C for securement around a user's head. The apparatus 200 includes a mask shell 205, filter 206, along with optional valve 207 and optional nosepiece 208. Multiple degrees of freedom may still be provided via a double connection of respective straps, with a single snap provided for further coupling the securement mechanisms to the mask shell 205. The single button connection facilitates a rotating pivot point, which may be combined with other adjustment of respective straps.

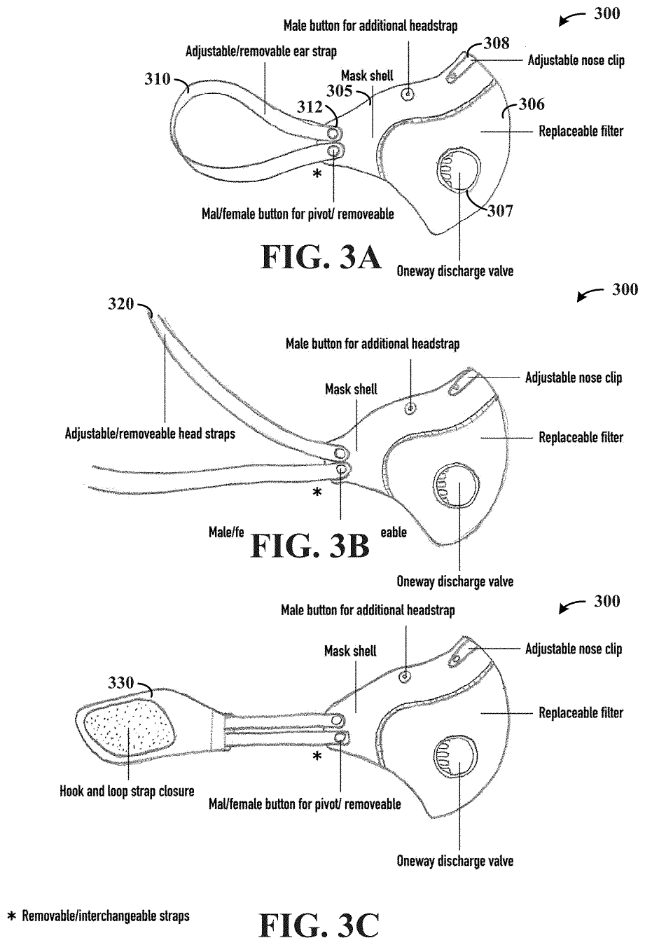

FIGS. 3A-3B show a mask apparatus 300 with various two-button detachable securement mechanisms, as may be implemented in accordance with one or more embodiments. FIG. 3A shows a two-button ear loop, FIG. 3B shows a two-button double strap for securement around a user's head, and FIG. 3C shows a two-button detachable hook-and-loop strap. Referring to FIG. 3A, the apparatus 300 includes a mask shell 305 and filter 306, and is shown with optional valve 307 and optional nosepiece 308. Combining a two-point securement with pivoting function provides an additional degree of freedom.

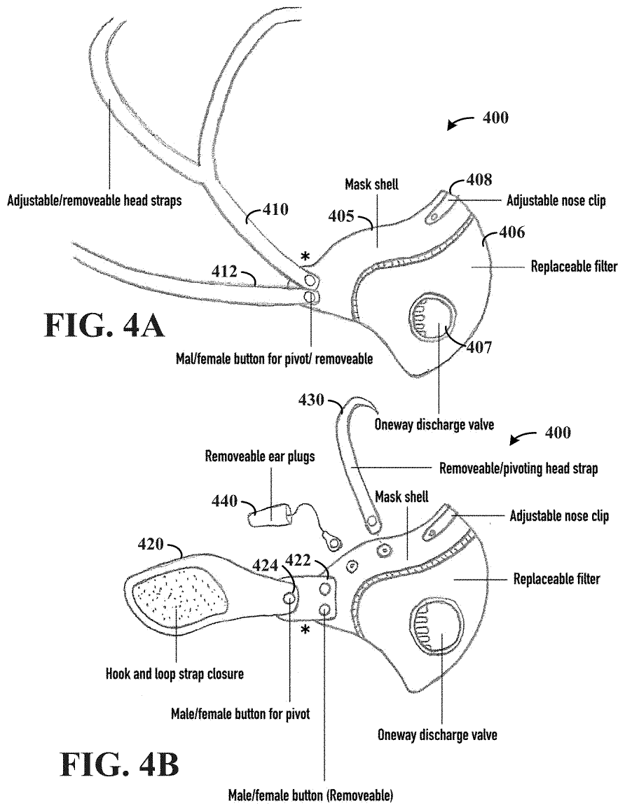

FIG. 4A shows a mask apparatus 400 with a two-button detachable double head strap, as may be implemented in accordance with one or more embodiments. The apparatus 400 includes a mask shell 405 and filter 406, and is shown with optional valve 407 and optional nosepiece 408. Each of two straps 410 and 412 are connected to the mask shell 405 via buttons.

FIG. 4B shows the mask apparatus 400 with a two-button detachable hook-and-loop strap 420 and various accessory items, as may be implemented in accordance with one or more embodiments. The accessory items include a removable head strap 430, removable ear plugs 440, and alternate snap options at 422 and 424, which provide respective degrees of freedom.

The mask shells depicted herein may be implemented with one or more variations. In some embodiments, valves are provided with adjustable air flow to hinder breathing ability for training purposes. For instance, adjustable air resistance valves can be implemented to increase or decrease resistance for lung capacity/strengthening. The valves may be adjustable with a twist, allowing for the user to define the amount of airflow through the mask. A water supply valve may also be implemented.

Filter securement can be made in other manners, in addition to or as an alternative to those noted above. In some embodiments, a mask shell as characterized herein is equipped with a snap (rivet) on the inside of the nose piece. The snap allows the user to insert a blank filter (no holes for exhalation), such as by snapping a male end of a snap/rivet into the mask. This allows the user to mask the scent of their breath by exhaling through the active carbon in the filter, for example as opposed to exhaling through unfiltered discharge valves. In some implementations, a one-way valve is utilized to provide unfiltered intake of air, with exhaled air passed through a carbon filter. Further, a filter can be omitted with a mask shell used to warm intake air, while allowing exhaled air to pass freely through a one-way valve.

In certain implementations, a filter cartridge is coupled to the mask for adding further puck type filters, such as active carbon filters. For instance, firefighters or workers in polluted environments can secure a variety of different types of filters in this regard. Different types or numbers of filters can be utilized in this regard.

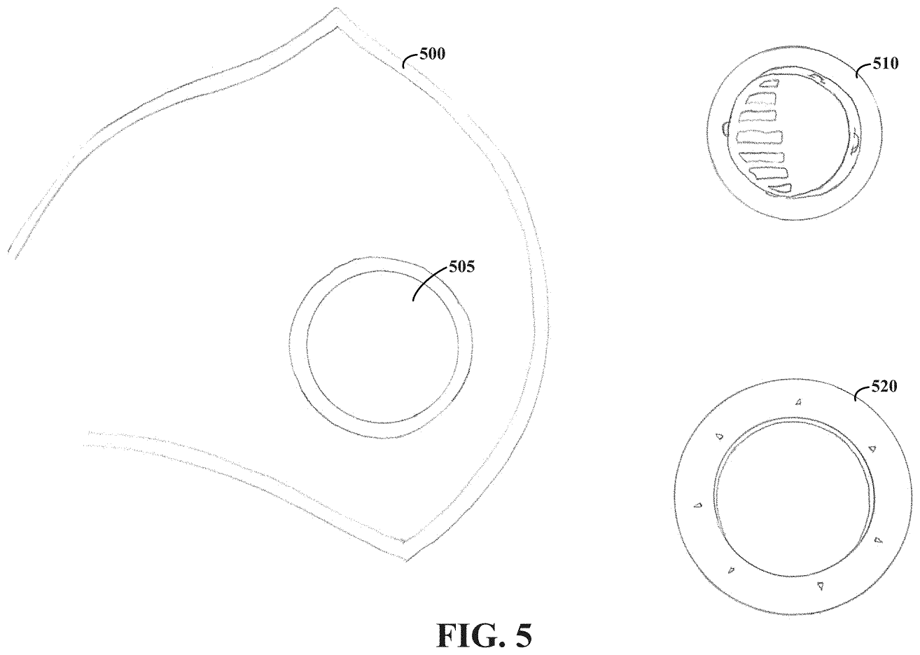

FIG. 5 shows a filter apparatus 500, as may be implemented in accordance with one or more embodiments. The filter apparatus 500 may be implemented with a valve 510, secured to an opening in the filter apparatus by flange 520. The filter apparatus 500 may, for example, be implemented with a mask shell as characterized herein, such as shown in FIGS. 1A-4B.

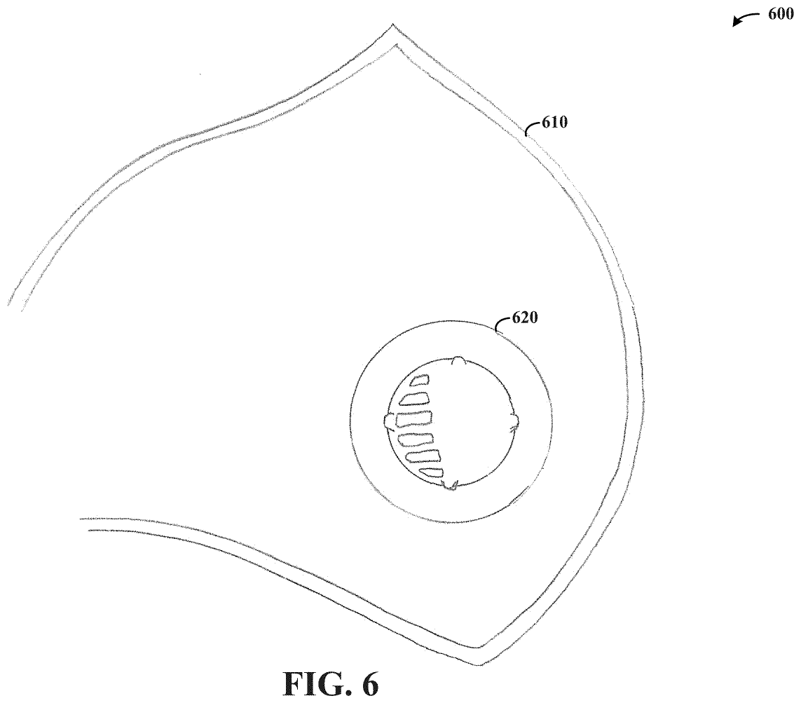

FIG. 6 shows a filter apparatus 600 with a vent assembly, as may be implemented in accordance with one or more embodiments. A filter 610 has a vent assembly 620 coupled thereto, which may be implemented with a flange and valve such as shown in FIG. 5.

The flange 520 may be compressed to a filter or mask shell as characterized herein to form a hole/insert in which the valve will protrude through. The flange 520 may be implemented with a soft, malleable aluminum round piece that has several small teeth on the outside of the flange that will be pressed against the mask fabric. The flange may also have an elevated ring that will then be compressed once placed in the hole of the mask fabric. Once compressed, the result is a rigid, round opening for the valve (attached to the filter) to be inserted. The valve 510 can be ultrasonic welded to the filter, and is shown with four small nubs around the outside sides. A user may push the valve through the compressed flange, with the open circle on the compressed flange being slight larger than the valve but smaller than the valve with the nubs, facilitating snug adherence between the replaceable filter and the mask. To replace the filter, a user may pull the valves/filter back out of the compressed flange, discard and repeat steps above.

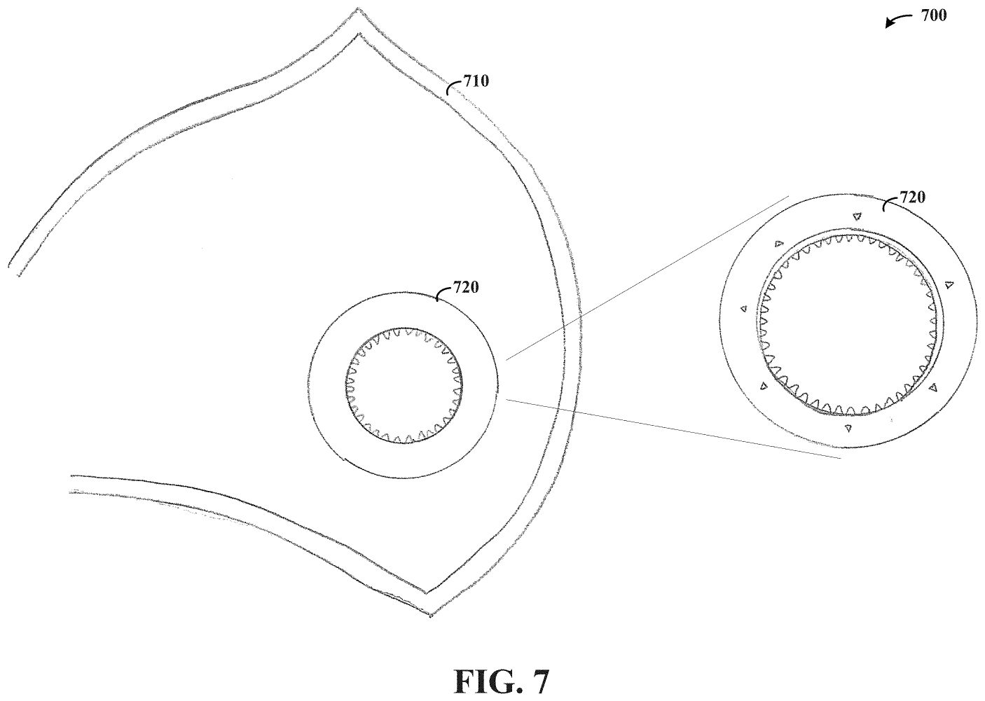

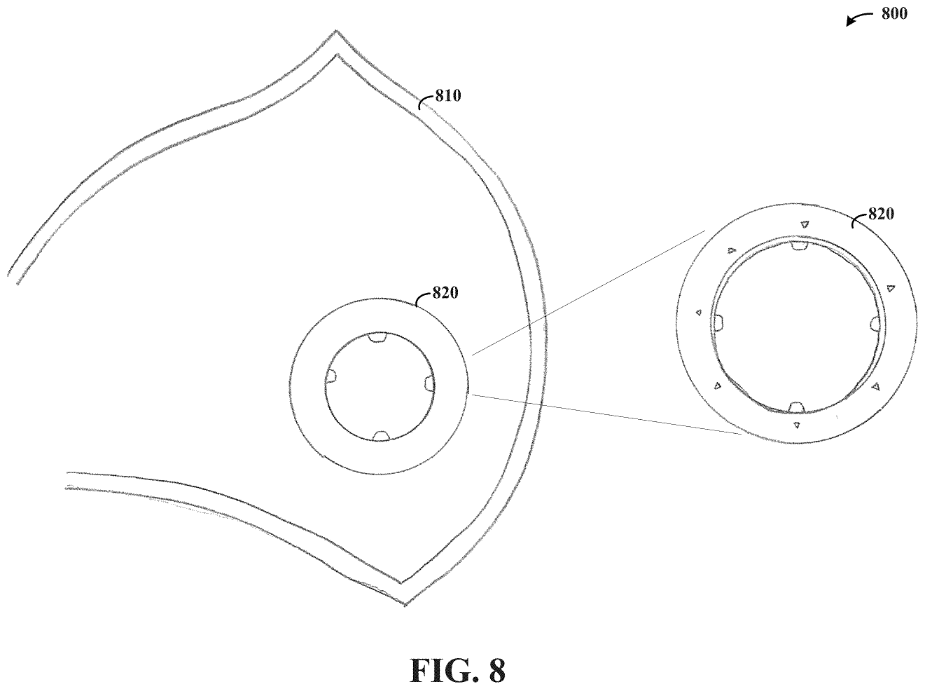

FIG. 7 shows a filter apparatus 700 having a filter 710 and a flange 720, as may be implemented in accordance with one or more embodiments. The flange 720 is shown in an inset, having teeth that engage with the filter 710. FIG. 8 shows a filter apparatus 800 with a vent assembly 820 attached to a filter 810, as may be implemented in accordance with one or more embodiments. The assembly 820 may be implemented with the flange 720 of FIG. 7.

The flange 720 can be compressed to the filter 710 or a mask shell to form a hole/insert in which a valve such as that shown in valve assembly 820 will protrude through. This flange can be a soft malleable aluminum round piece that has several small teeth on the outside of the flange that will be pressed against the mask fabric. The flange may also have an elevated ring that can be compressed once placed in the hole of the mask fabric. The inside of this flange, where the valve will be pushed through, may have four small nubs (e.g., as shown at 820). These nubs will provide a snug hole for the valve to be pushed through. The nubs on the flange will hold the valve/replaceable filter in place. Once compressed, the result is a rigid, round opening with nubs, for the valve (attached to the filter) to be inserted. The valve assembly 820 may be ultrasonic welded to the filter 810. The user may push the valve through a compressed flange, with the open circle on the compressed flange with nubs being slightly smaller than the circumference of the valves, resulting in a snug adherence between the replaceable filter and the mask. When it comes time to replace the filter the user will simply pull the valves/filter back out of the compressed flange, discard and repeat steps above.

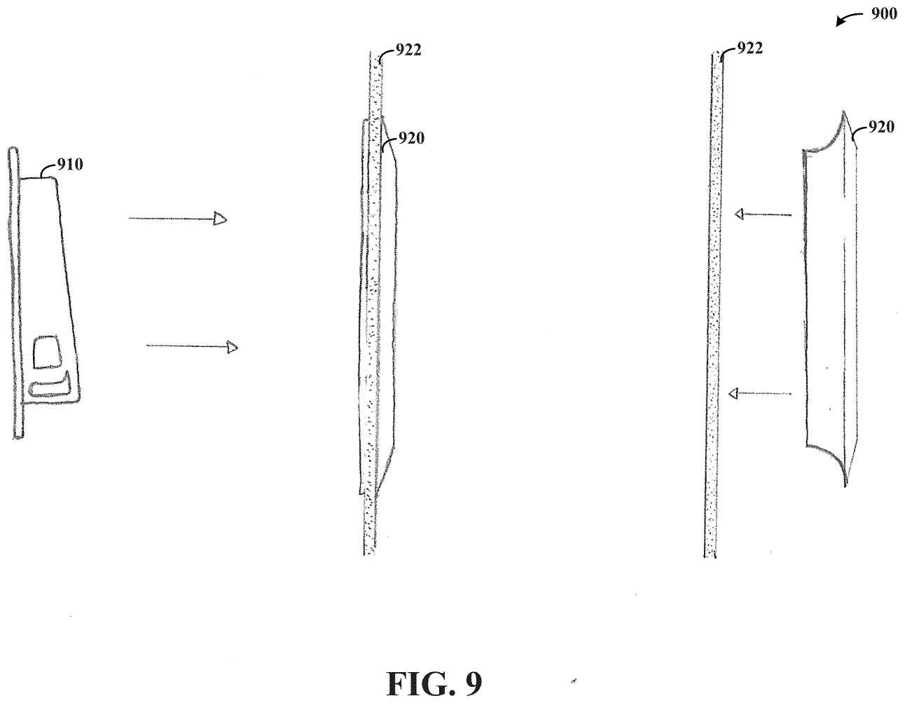

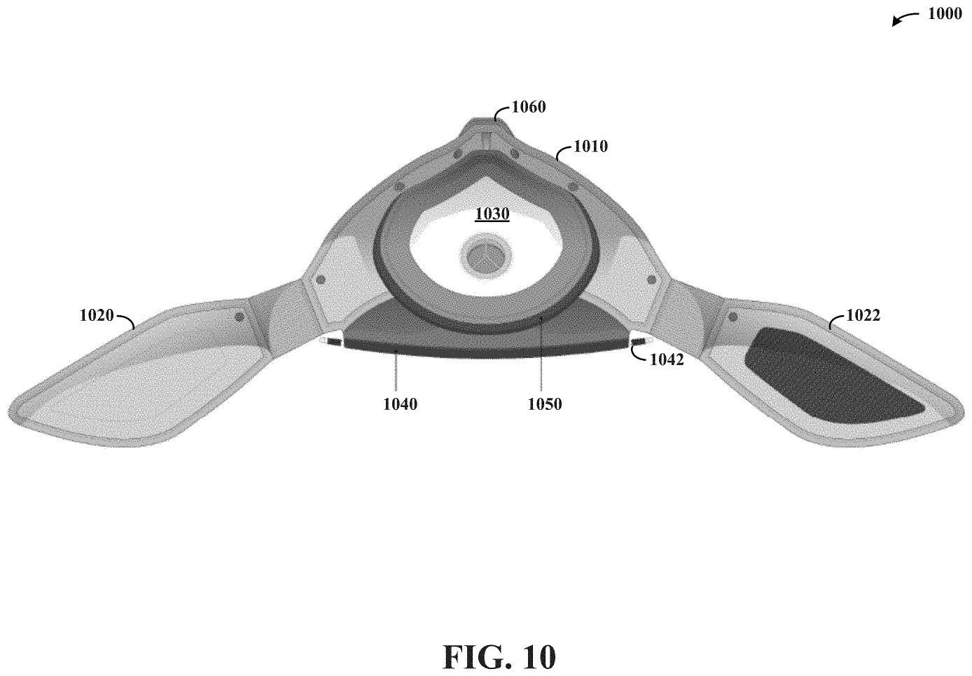

FIG. 9 shows a vent assembly 900 for use with a filter and/or mask, as may be implemented in accordance with one or more embodiments. The assembly 900 includes a valve 910 and a flange 920 that can be secured to a filter 922. As shown on the right side of FIG. 9, the flange 920 is pushed through and engaged with the filter 922. The valve 910 can then be pushed through the flange to form a final assembly (e.g., similar to that shown in FIG. 6).

FIG. 10 shows a mask apparatus 1000, as may be implemented in accordance with one or more embodiments. The apparatus 1000 includes a shell 1010 that incorporates with straps 1020 and 1022 to secure a mask 1030 to a user's head. The shell 1010 can be implemented with a variety of materials and shapes, to suit particular embodiments. The straps 1020 and 1022 operate to secure to one another or another component on a user, applying a force to the mask 1040 against the user's face via the shell 1010.

The shell 1010 can be implemented in a variety of manners. In some implementations, the shell is solid and covers an outer surface of the mask 1030 (in the drawing as shown in FIG. 10, an inner surface of the mask is shown with an outer surface facing away). In other implementations, the shell 1010 has one or more openings via which the outer surface of mask 1014 may be exposed. In either implementation, an inner surface of the shell 1010 operates to apply the aforementioned force against the mask 1040 when the shell is coupled to a user's face via straps 1020. In this context, the mask 1030 may be independent from the shell 1010 in an unsecured state, and be secured/pressed against a user's face in a secured state. In this context, a removable or disposable mask such as described above can be affixed around a user's nose and mouth to provide air filtration. The shell 1010 operates to apply pressure to the mask, such as an even force around the user's nose and mouth that creates a seal.

One or more components shown in FIG. 10 can be implemented separately, or in combination, to suit various embodiments. Further, the apparatus 1000 can be implemented with a variety of characteristics, such as those described herein. For instance, in some embodiments a securing foam or other material 1040 is employed to enhance fitment to a user, such as to accommodate facial hair while maintaining a seal. A tensioning component 1042 may further be employed to tension the material 1040. Some embodiments involve material such as foam used at 1050 to guide placement of the mask 1030 relative to the shell 1010. A nosepiece 1060 can be implemented to enhance sealing of the shell 1010 to the user, mitigating issues such as those relating to moisture escape that can fog eyewear.

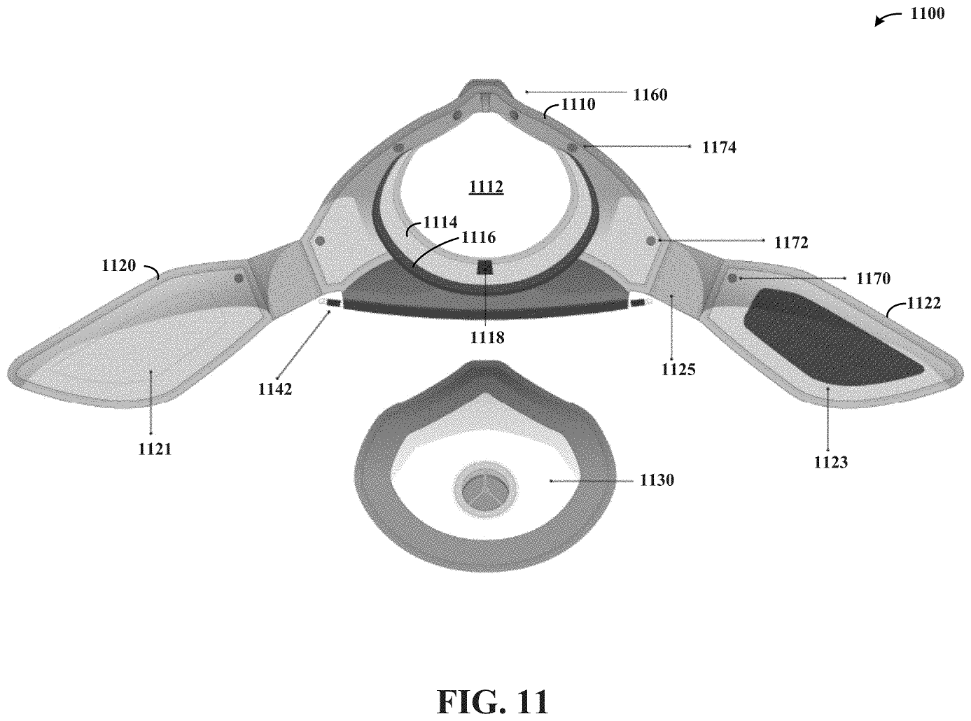

FIG. 11 shows another mask apparatus 1100, as may be implemented in accordance with one or more embodiments. The apparatus 1100 may, for example, be implemented in accordance with the apparatus 1000 shown in FIG. 10, and in this context various similar reference numerals are used for similar components (e.g., mask 1110, straps 1120 and 1122, mask 1130, tensioning component 1142, and nose piece 1160).

By way of example, the shell 1110 is shown with an opening at 1112 that accommodates mask 1130. An inner surface of the shell 1110 at region 1114 interfaces with an outer surface of the mask 1130 near an edge thereof, and applies a force (with the straps 1120 and 1122 engaged) that secures the mask against a user's face. Accordingly, region 1114 of the shell 1110 can be shaped to conform to the mask 1130, with a portion of an outer surface of the mask being exposed via opening 1112 when held in place. A guide 1116, such as a foam guide, operates to align the mask 1130 with the shell 1110. A fastener 1118, such as a hook, may be implemented to help secure the mask 1130 to the shell 1110 while the mask/shell combination is fitted to a user and secured via the straps 1120 and 1122.

A variety of additional components are shown in FIG. 11, one or more of which may be implemented with the apparatus 1100. For instance, straps 1120 and 1122 may be secured to one another with hook-and-loop type fasteners 1121 and 1123 (one including hooks and the other loops), and may employ a stretchable material as shown at 1125 to secure the shell to a user. A plurality of connectors can be implemented at various connection points, such as 1170, 1172 and 1174, for connecting accessories such as earplugs, safety glasses and a head strap.

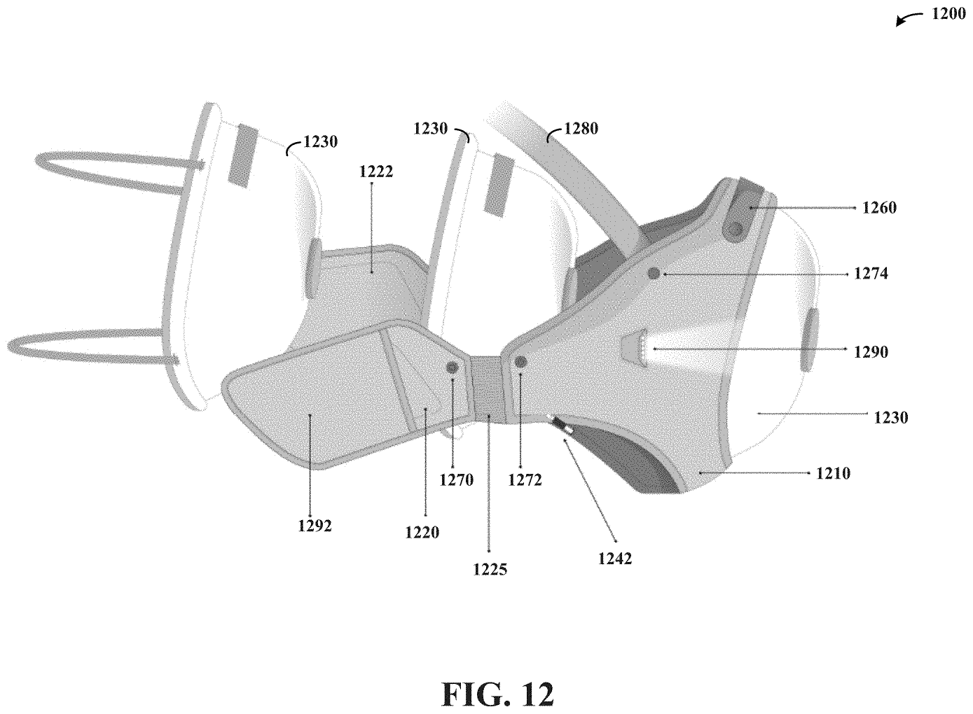

FIG. 12 shows a mask apparatus 1200 with insertion of a replaceable mask 1230, in accordance with various embodiments. The apparatus 1200 may be implemented in accordance with the apparatus 100 shown in FIG. 1 and/or with the apparatus 1100 shown in FIG. 11. In this context various similar features are not described further in FIG. 12, but are understood as being implementable with the features described in FIGS. 1 and 11. Such features may include shell 1210, nosepiece 1260, a headstrap rivet 1274, tensioning component 1242, a stretchable component 1225, straps 1220 and 1222, ear plug rivet 1270 and safety glasses rivet 1272.

The apparatus 1200 shows mask 1230 at different locations as it is being installed or removed. The apparatus 1200 may also be implemented with a light 1290, which can be powered via a batter as may be kept in a storage pouch 1292.

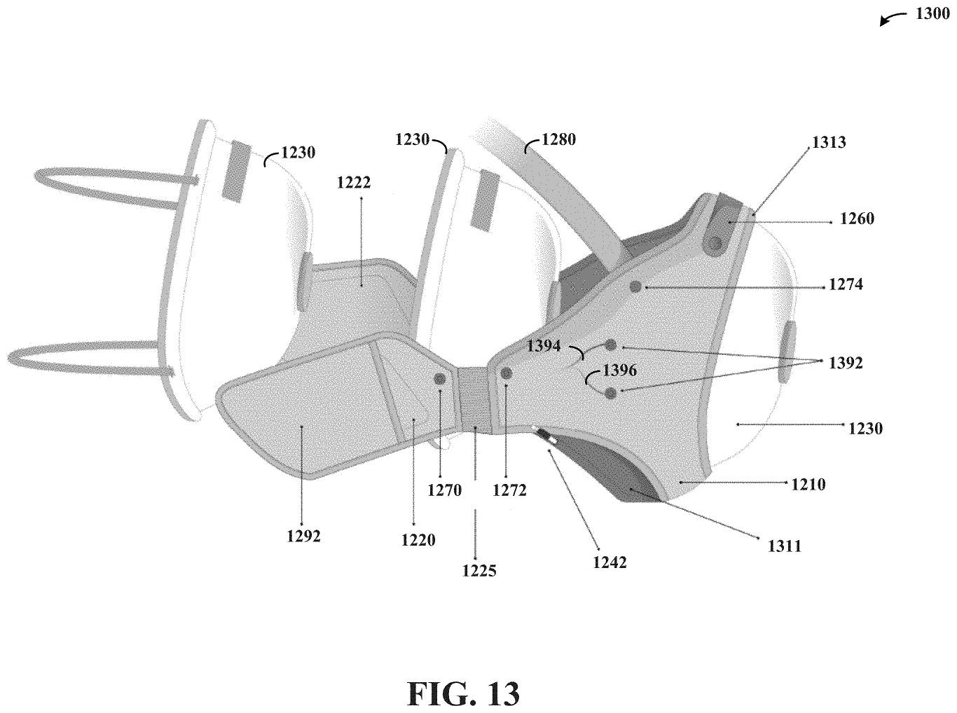

FIG. 13 shows a mask apparatus 1300 similar to the apparatus 1200 shown in FIG. 12, with common reference numerals used to refer to components that may be implemented similarly. FIG. 13 also shows stretchable material 1311 (e.g., spandex), an elastic cord 1313 sewn in or otherwise integrated with mask 1210, and terminals 1392 having wire leads 1394 and 1396 (shown in a partial cut-away view) coupled to the terminals. These wire leads may, for example, lead back to pouch 1292 in which a battery may be placed and coupled (e.g., with an additional battery connector therein and/or with a battery integrated within the mask).

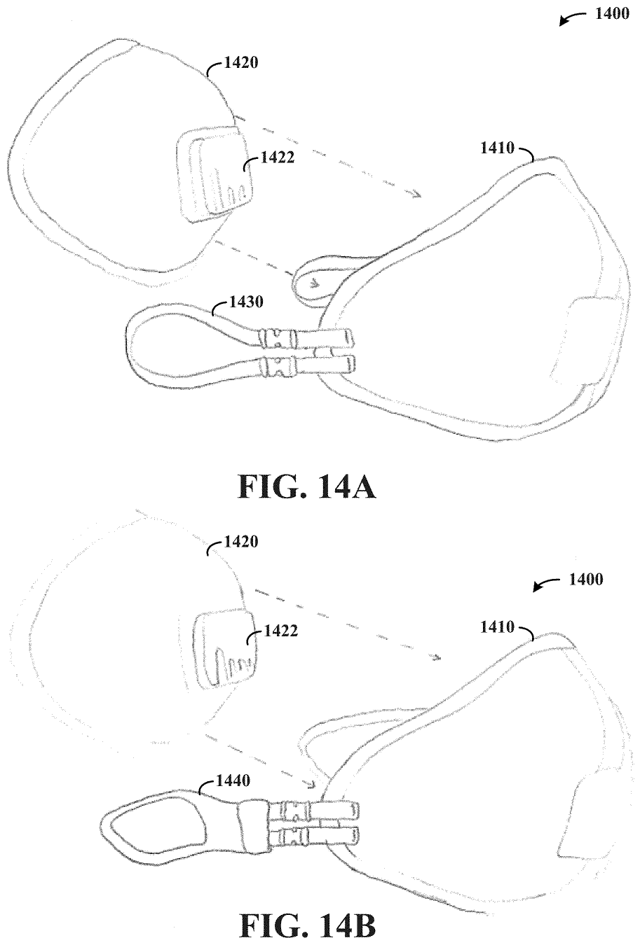

FIG. 14A shows a mask apparatus 1400 with a replaceable mask having a central valve region, in accordance with one or more embodiments. The apparatus 1400 includes a mask shell 1410, which is configured to accommodate a filter 1420 having a central valve region 1422. The apparatus 1400 may include the filter 1420 as well. The mask shell 1410 is shown coupled to a securing mechanism 1430 for securing around a user's ears. In some embodiments, the apparatus includes the securing mechanism 1430.

FIG. 14B shows the mask apparatus 1400 of FIG. 14A with a different securing mechanism 1440, having a hook-and-loop type fastener. The apparatus 1400 as shown in FIG. 14B also includes the mask shell 1410, and may include filter 1420 and the securing mechanism 1440.

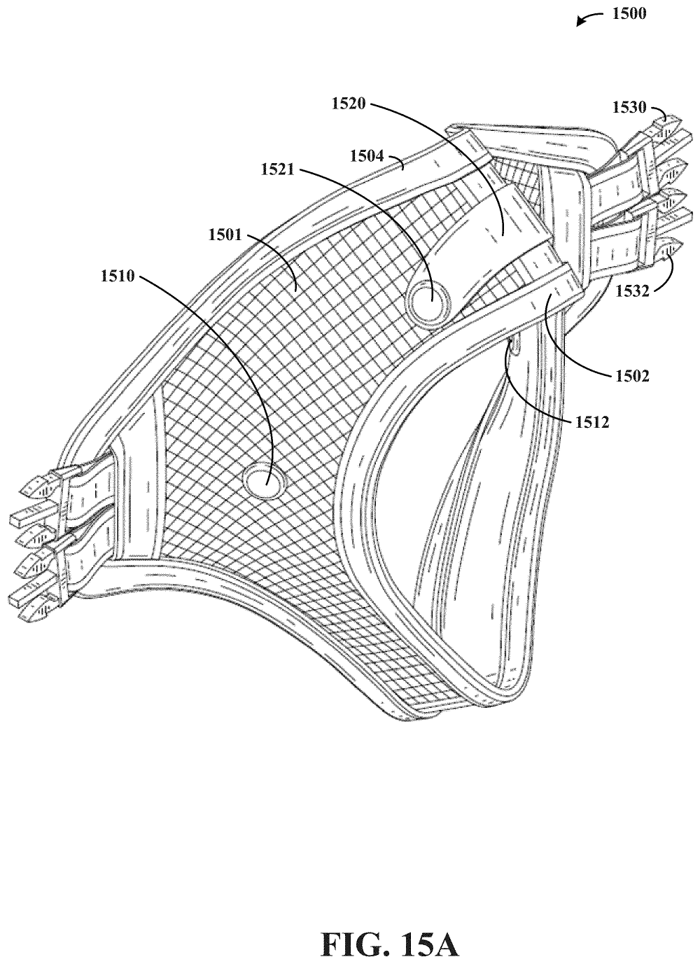

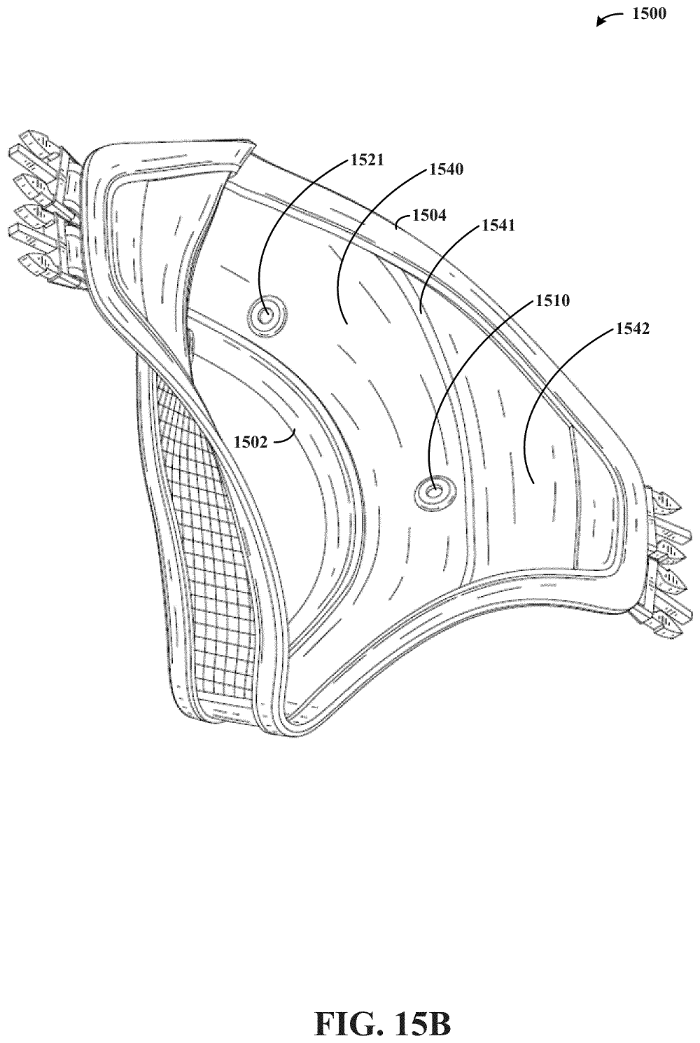

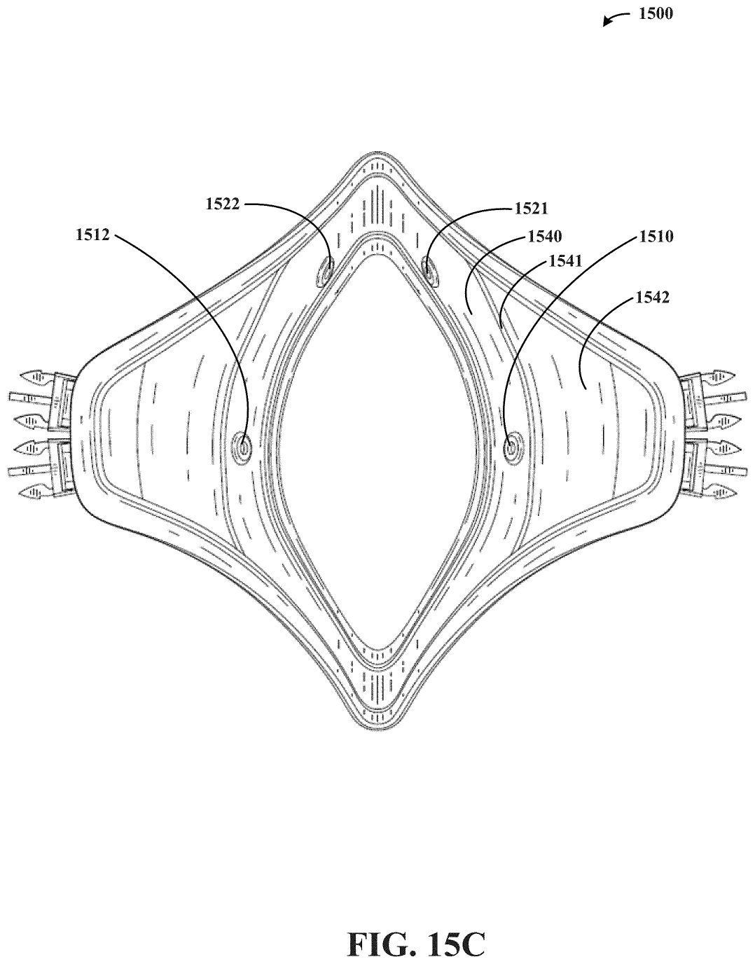

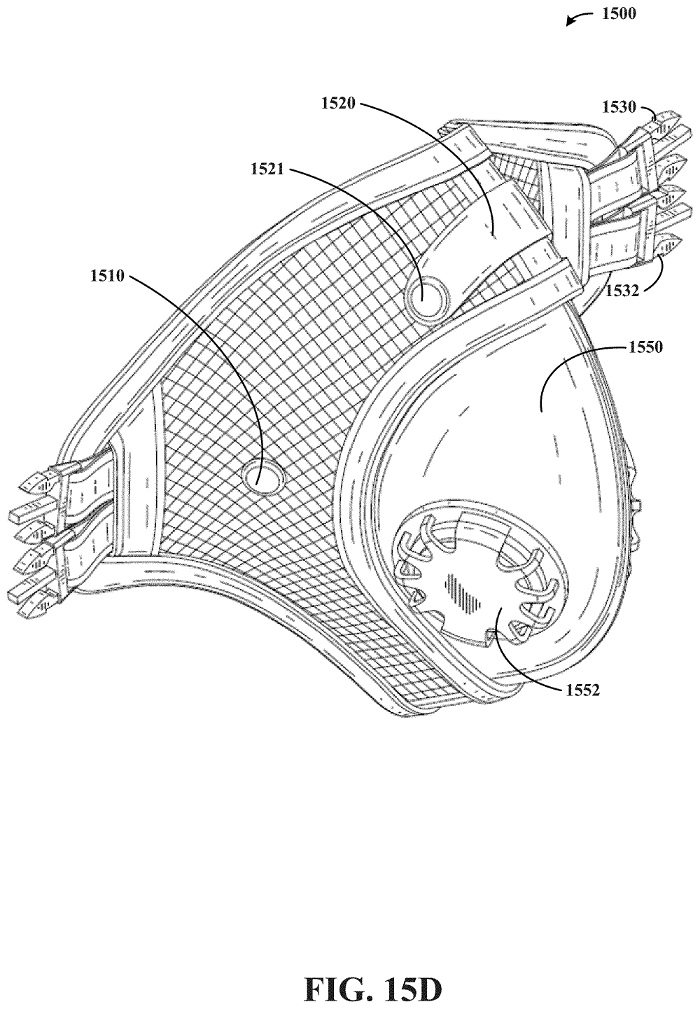

FIGS. 15A-15D show a mask apparatus 1500 in accordance with one or more embodiments. Beginning with FIG. 15A, a front right perspective view of a mask shell 1501 is shown, in which the mask shell has an inner perimeter 1502 that defines an opening, and an outer perimeter 1504, with material therebetween. While the mask shell 1501 is depicted with a cross-hatched type material, various embodiments employ a smooth or other-patterned material. The mask shell 1501 includes fasteners 1510 and 1512, configured to connect to a replaceable filter. The fasteners 1510 and 1512 may, for example, be snap fasteners, such as female snap fasteners configured to accept a male snap fastener coupled to such a replaceable filter. The mask shell 1501 is shown including an optional nosepiece 1520, secured to the mask shell via fastener 1521. The fastener may be a rivet, or a fastener such as a snap fastener that may secure the nosepiece and also couple to another fastener on the filter. Connectors for securing the mask shell to a user's face are shown, with connectors 1530 and 1532 labeled by way of example.

FIG. 15B shows a rear left perspective view of an implementation of the mask shell 1501 of the apparatus 1500. Fasteners 1510 and 1521 are depicted as female snap fasteners for coupling to a filter. The mask shell 1501 includes a reinforced portion 1540 adjacent the inner perimeter 1502 and a breathable portion 1542, on opposing sides of an interface region 1541. Consistent with the above, it has been recognized/discovered that the use of reinforcement at 1540 facilitates repeated replacement of filters that are coupled to the mask shell 1501, while the breathable portion 1542 facilitates comfort.

FIG. 15C shows a rear view of the mask shell 1501, in accordance with another implementation. Fastener 1522 is shown in addition to fasteners 1521, 1510 and 1512 as discussed above. These four fasteners are coupled to the reinforced portion 1540 of the mask shell 1501 and configured for repeated attachment and detachment of replaceable filters.

FIG. 15D shows a perspective view of an implementation of the apparatus 1500 in which a filter 1550 having a valve 1552 is connected to the mask shell 1501. The valve 1552 is optional, and the filter 1550 may be implemented in a variety of manners with a variety of materials. The filter 1550 includes fasteners that couple to the mask shell 1501, including a fastener positioned to couple to fastener 1510 (e.g., a male snap fastener, which may be riveted or glued to the filter). Accordingly, the mask shell 1501 operates to secure a perimeter of the filter 1550 to a user's face when applied thereto, while allowing air to flow through the filter. Further, multiple different types of filters can be coupled to the mask shell in this regard, to suit particular uses, providing versatility to the mask shell.

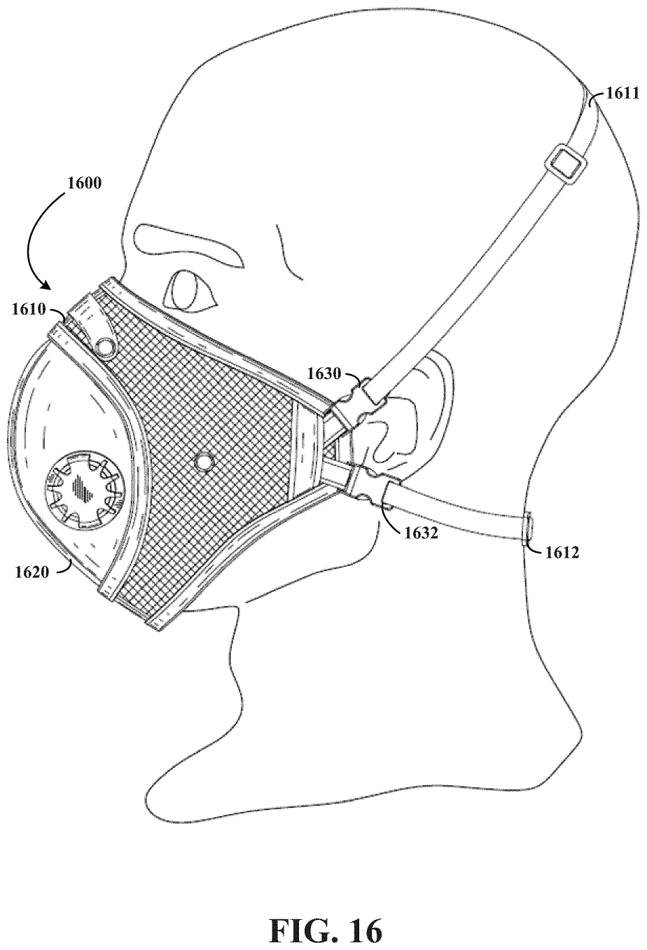

Mask apparatuses characterized herein, such as mask apparatus 1500, may be secured to a user's face in one or more of a variety of manners. FIGS. 16-18 show example securing mechanisms, in accordance with various embodiments. Beginning with FIG. 16, a dual strap mask apparatus 1600 is shown applied to a user, in accordance with one or more embodiments. The apparatus 1600 includes a mask shell 1610 and filter 1620, which may be implemented using mask shell 1501 and filter 1550 as shown in FIG. 15D. A first strap 1611 is connected to the mask shell 1610 via fastener 1630, and a second strap 1612 is connected to the mask shell 1610 via fastener 1632.

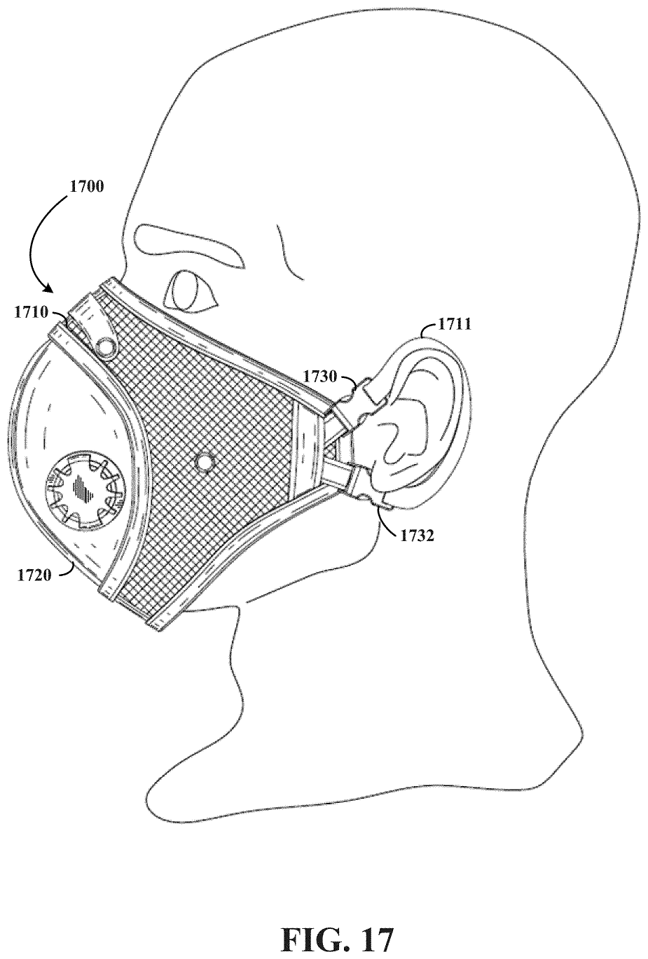

FIG. 17 shows an ear mask apparatus 1700 as applied to a user, in accordance with one or more embodiments. A mask shell 1710 and filter 1720 as coupled to a user's ears via strap 1710, which is coupled at respective ends to the mask shell via fasteners 1730 and 1732.

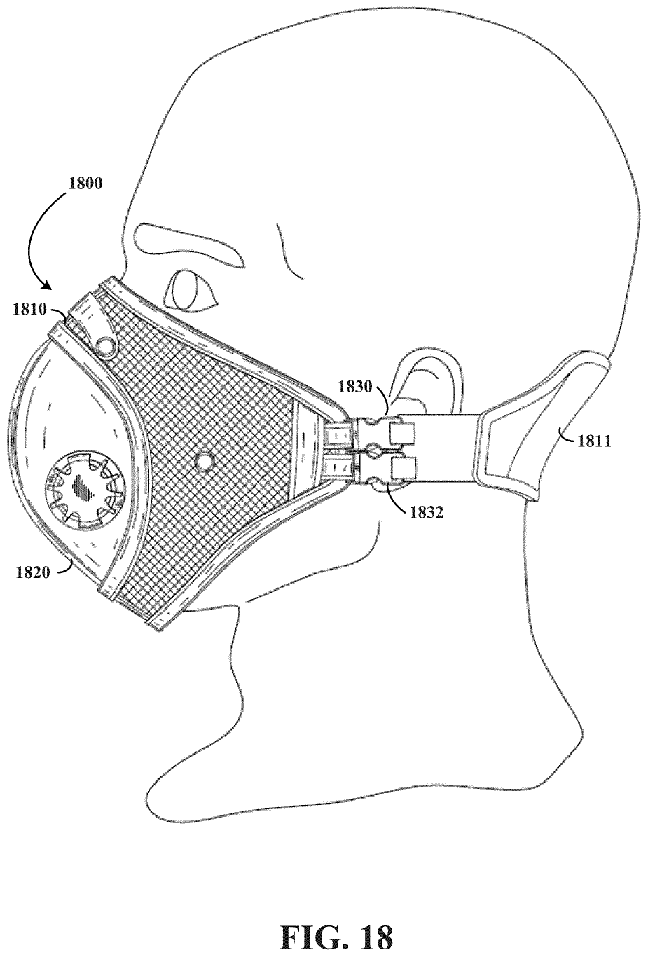

FIG. 18 shows a single strap mask apparatus 1800 as applied to a user, in accordance with one or more embodiments. A mask shell 1810 and filter 1820 are secured to a user's face via strap 1811, which is coupled to the mask shell via fasteners 1830 and 1832.

Accordingly, as denoted in FIGS. 16-18, a variety of strap options can be utilized with a mask shell/filter mask apparatus. As such, the straps apply a force on the mask shells toward the user's face, securing the filter between the mask shell and the user's face and around the user's nose and mouth. Further, reinforcement can be placed within the mask shells as shown, in a manner such as characterized with FIGS. 15A-15D, to facilitate replacement of the filters and otherwise provide a secure seal around the user's nose and mouth.

Based upon the above discussion and illustrations, those skilled in the art will readily recognize that various modifications and changes may be made to the various embodiments without strictly following the exemplary embodiments and applications illustrated and described herein. For example, various types of materials can be used, in addition to and/or in alternative to those listed. Strap placement may vary to accommodate different anatomies. In addition, the various embodiments described herein may be combined in certain embodiments, and various aspects of individual embodiments may be implemented as separate embodiments. The embodiments shown in the figures and/or as described herein may be implemented together, or certain components characterized with particular embodiments may be used separately. Such modifications do not depart from the true spirit and scope of various aspects of the invention, including aspects set forth in the claims.

What is claimed is:

1. An apparatus comprising:
a filter configured and arranged to conform to a user's face and to filter air while conformed to the user's face;
a mask shell having an inner periphery defining a central opening and having an elastic material, the mask shell being configured and arranged to:
conform to the user's face with the filter between the mask shell and the user's face and held against the user's face, with the inner periphery of the mask shell extending around a perimeter region of the filter with a central portion of an outer surface of the filter being exposed via the opening and permitting air to pass between an ambient environment in contact with the filter and the user's nose and mouth via the filter; and
seal the filter around the user's nose and mouth by applying pressure to the filter and the user's face at the perimeter region of the filter; and
a securing mechanism including first and second opposing portions connected to respective sides of the mask shell, and including first and second couplers respectively coupled to the first and second opposing portions, the securing mechanism being configured and arranged with the elastic material to, with the filter positioned between the mask shell and the user's face, seal the filter around the user's nose and mouth, by utilizing the user's head for applying a securing force to the filter via the respective sides of the mask shell, with the respective sides being positioned on opposing sides of the user's face, in a direction toward the user's face.

2. The apparatus of claim 1, wherein the second coupler is separate from the first coupler and configured and arranged to move independently of the first coupler, the first and second couplers being configured and arranged to apply the securing force in different directions relative to one another.

3. The apparatus of claim 1, wherein the second coupler is separate from the first coupler, the first and second couplers connecting the securing mechanism to the mask shell and being configured and arranged with the mask shell and securing mechanism to provide, via each of the first and second couplers, respective degrees of freedom of relative motion between the mask shell and the securing mechanism.

4. The apparatus of claim 3, wherein the first and second couplers are configured and arranged for attaching and detaching the securing mechanism to the mask shell.

5. The apparatus of claim 3, wherein at least one of the first and second couplers includes a first portion connected to the securing mechanism and a second portion connected to the mask shell, the first and second portions being configured and arranged to connect the mask shell to the securing mechanism by detachably engaging with one another.

6. The apparatus of claim 3, wherein each of the first and second couplers is configured and arranged to provide respective degrees of freedom that provide forces in different directions that respectively provide different securing forces upon the mask and the user's face.

7. The apparatus of claim 1, wherein the mask shell has an open region having a perimeter that, when secured to the user's face, exposes an exterior surface region of the filter that is over the user's nose and mouth, with an interior surface region of the filter in contact with the user's face.

8. The apparatus of claim 1, wherein the mask shell is configured and arranged with the filter to secure a perimeter inner surface of the filter to the user's face, with the mask shell covering a perimeter outer surface of the filter and an elastic material along the an interface between the mask shell material and the filter, and with a central area of the outer surface of the filter being uncovered by the mask shell and exposed to communicate air directly between the central area of the outer surface of the filter and a corresponding central area of an inner surface of the filter.

9. The apparatus of claim 1, further including a valve component configured and arranged to pass air in a first direction through the filter, and to mitigate air from passing through the valve in the filter in a second direction that is opposite the first direction.

10. The apparatus of claim 9, wherein the valve component is secured to the filter and unconnected to the mask shell.

11. The apparatus of claim 1, wherein the mask shell:
has an inner perimeter defining an opening through the mask shell,
has a reinforced portion adjacent the inner perimeter and having a snap fastener configured to couple to the filter,
has a breathable portion beyond the reinforced portion, in which the reinforced portion lies between the inner perimeter and the breathable portion, and in which the breathable portion lies between the reinforced portion and the securing mechanism, and
is configured to, with the filter coupled to the snap fastener, secure the filter to the user's face with the inner perimeter extending around the user's nose and mouth while an outer surface of the filter is exposed via the opening defined by the inner perimeter with the filter covering the user's nose and mouth.

12. An apparatus comprising:
a filter; and
a mask shell including
a first material portion configured and arranged to conform to an outer perimeter of the filter, and having an inner perimeter including an elastic material and defining an opening in the mask shell via which an external surface of the filter is exposed to pass air, and
a second securing portion connected to the first material portion and configured and arranged with the elastic material of the first material portion and the filter to, with an outer perimeter portion of the filter positioned between the first material portion and a surface, secure the filter to the surface with the filter covering a portion of the surface and the inner perimeter of the first material portion extending around part of the covered portion of the surface, by applying a securing force to the filter via the first material portion in a direction toward the surface.

13. The apparatus of claim 12, wherein the first material portion is configured and arranged with the second securing portion to conform the filter to a user's face by applying a force that presses the inner perimeter of the mask shell around the user's nose and mouth with the exposed portion of the filter covering the user's nose and mouth and thereby sealing the filter around the user's nose and mouth.

14. The apparatus of claim 12, wherein
the filter and mask shell are configured and arranged to move independently of one another in an unsecured state; and
the second securing portion is configured and arranged to secure an inner surface of the first material portion with an outer surface of the filter, with an inner surface of the filter being in contact with and secured to a user's face, in a secured state in which the securing force secures the filter relative to the mask shell.

15. The apparatus of claim 12, wherein the filter includes a snap fastener and wherein the first material portion includes:
a reinforced portion having a snap fastener configured to secure the filter to the mask shell by snapping to the snap fastener of the filter, and configured to decouple from the filter via the snap fasteners for replacement thereof; and
a breathable portion configured to facilitate enhanced passage of air relative to the reinforced portion, the reinforced portion being bound by inner perimeter and the breathable portion, the breathable portion being bound by the reinforced portion and the second securing portion.
